(19) United States
(12) Patent Application Publication
(10) Pub. No.: US 2007/0180030 A1
(43) Pub. Date: Aug. 2, 2007

(54) METHOD FOR REALIZING DYNAMIC QOS IN WIMAX SYSTEM

(75) Inventors: Zizhen Xu, Shenzhen, GD (CN); Tao Wu, Shenzhen, GD (CN); Ruobin Zheng, Shenzhen, GD (CN)

Correspondence Address: FISH & RICHARDSON PC, P.O. BOX 1022, MINNEAPOLIS, MN, 55440-1022, US

(73) Assignee: HUAWEI TECHNOLOGIES CO., LTD., Shenzhen, GD (CN)

(21) Appl. No.: 11/570,750

(22) PCT Filed: May 11, 2006
(86) PCT No.: PCT/CN06/00943

§ 371 Date: Dec. 15, 2006

(30) Foreign Application Priority Data
May 15, 2005 (CN) 200510034686.7

(51) Int. Cl. G06F 15/16

(52) U.S. Cl. 709/204; 709/200; 370/396; 370/395.5

(57) ABSTRACT

Method for realizing dynamic QoS in a WIMAX system includes: a Media Gateway Control MGC makes awareness of a service stream from a Media Gateway MG, and transmits a resource request to a Resource Management Server RMS, which, in response to the request, decides whether there is enough resource; and if yes, confirms the request, and transmits a resource allocation instruction and QoS parameters matching the resource type to a Base Station BS, which, after receiving the instruction, allocates resource to a Subscriber Station SS, thus a channel from the MGC to the MG via BS and SS is established; or if not, refuses the request. According to the method, BS or SS do not make awareness of services, and no bandwidth preservation is needed for UGS or Realtime-polling service streams, and QoS parameters are issued dynamically by a RMS. Thus network resource management is more flexible and convenient.

### FIELD OF THE INVENTION

The present invention relates to wireless access technology, and particularly to a method for realizing dynamic QoS in WIMAX system.

### BACKGROUND OF THE INVENTION

BWA (Broadband Wireless Access) in current communication market, as a solution with high speed and low cost, is applied widely, in which WIMAX (Worldwide Interoperability for Microwave Access) based on 802.16 standard is a wireless Metropolitan Area Network technology which can realize “last mile” access, technically solving problems of physical layer environment (outdoor Radio Frequency (RF) transmission) and QoS (Quality of Service), so that WIMAX products can be used indoors and outdoors, and can deal with data access and voice and video services with higher real-time requirements, which can not be done by other BWA technologies.

Internet can provide services of only one level in the past, i.e. “best effort” service, in which, all data packets are treated equally, but actually, Internet can not ensure uniform quality service. When high congestion occurs in network, quality service will be very low. “Best effort” service has already not adapted to Internet-based voice and video applications and can not satisfy subscriber requirements very well. A solution which is put forward to meet different subscriber requirements is referred to as QoS, i.e. during network communications, subscriber services can attain to an expectable service level in aspects of packet loss ratio, delay, jitter and bandwidth. Technical problems to be solved by IP QoS include: avoiding congestion in IP network and managing IP network; decreasing loss ratio of IP packets; regulating traffic of IP network; providing bandwidth dedicated to specific subscribers or specific services; sustaining real time services over IP network.

Data transmission in WIMAX system is connection-oriented, in which all data, upstream or downstream, are transmitted in association with a certain connection. Service stream carries one class of one-way data stream, and has lots of related attributes and three states, and when the state of service stream becomes Admitted state or Active state, the service stream is also referred as a connection. 4 types of service stream are defined in 802.1x, with different types of service stream having different bandwidth scheduling features, bandwidth request modes, and QoS parameter sets. All service data streams have a 32-bit SFID (Service Flow IDentifier) which is allocated by a BS (Base Station).

The types of service include: UGS (Unsolicited Grant Service), Rt-PS (Real-time Polling Service), Nrt-PS (Non real-time Polling Service) and BES (Best Effort Service).

UGS service: UGS service needs preserved bandwidth. BS will periodically notify SS (Subscriber Station) of available timeslot/bandwidth. There is no need for SS to transmit a bandwidth request and Bandwidth can be guaranteed. It is applicable to services with higher priority, and mainly applied to real-time services with fixed-length packets, such as T1/E1, VoIP (Voice over IP) and ATM private line.

Rt-PS service: does not preserve bandwidth, but bandwidth can be guaranteed and can be requested when needed. BS will allocate periodic bandwidth request timeslots to SS which are used for SS to request bandwidth from BS. It is applicable to services with high real-time requirement, and mainly applied to support real-time video services.

Nrt-PS service: BS allocates non-periodic bandwidth request timeslots or competition request timeslots to SS; the request timeslots, if allocated, are very short intervals, ensuring that the service has transmission opportunities even in case of network congestion. It is applicable to services with low real-time requirement, such as FTP.

BES service: BES service transmits services with best effort. BES service transmits services upon obtaining bandwidth using a competition request timeslot allocated by BS. Bandwidth can not be guaranteed. BES service is applicable to services with lower priority, such as Web browsing and sending/receiving E-Mail.

Each type of service has a corresponding QoS parameter set, in which several main QoS parameters are:

Maximum Sustained traffic rate of a service stream: its unit is bits/s. SS must ensure that, in an upstream direction, an average rate of the service stream does not exceed the Maximum Sustained traffic rate. In an downstream direction, the traffic rate can be restricted at an ingress side of BS;

Maximum traffic burst of a service stream;

Minimum reserved traffic rate: if a requested bandwidth for a stream is less than the Minimum reserved traffic rate in a certain timeslot, BS will allocate remaining bandwidths to other streams temporarily;

Minimum tolerable traffic rate: BS will determine whether to modify traffic rate of a link or to delete the link according to the Minimum tolerable traffic rate and actual traffic rate;

Tolerated jitter: defines the maximum delay jitter of a stream. Its unit is ms.

maximum latency: Maximum latency defines the maximum latency from a message having been received by a BS (or SS) from a network side till the message being transmitted from a RF interface.

There are two provisioning modes of resource (such as bandwidth): static provisioning and dynamic provisioning. Static provisioning means one in which service streams are issued through configuration by an entity, such as a network management system, a provisioning server, etc; dynamic provisioning means that service streams are dynamically issued through allocation of service streams parameters by a certain entity when service requirements (such as voice dial, connection, communication) really exists. Conventionally, QoS parameters are configured statically on BS and SS.

Since voice service has a very high requirement on bandwidth and delay, UGS service preserves bandwidth and such bandwidth is exclusive and non-shared; Rt-PS does not preserve bandwidth, but bandwidth therein can be guaranteed and can be requested when needed, so bandwidth and delay therein can be guaranteed. So the types of voice service are all defined as UGS service. Assuming an MG (Media Gateway) can accommodate 8 channels of voices, and all the 8-channel voice services are UGS service, an air interface (an interface between BS and SS is referred as an air interface) will preserve bandwidth for the 8-channel voice service stream respectively no matter whether voice channels are established or not, thus utilization rate of air-interface bandwidth is very low, which results in waste of air-interface bandwidth. Awareness service means that a device can parse a message, for example, the characteristic of a VoIP message is a specific UDP port number, then in order to become aware of a VoIP service, UDP port number of VoIP message should be parsed, in order to become aware of service streams, such as VoIP service stream, etc., and perform process specifically based on service streams. In order to become aware of VoIP service stream, application layer in TCP/IP protocol stack should be analyzed. Traditional service awareness is performed by BS or SS, and QoS parameters are configured specifically on BS or SS, which results in increased complexity of device implementation, lower processing performance of devices and increased cost, and is unfavorable for interconnection and intercommunication between WIMAX devices.

### SUMMARY OF THE INVENTION

The embodiments of the present invention aim to provide a method for realizing dynamic QoS in a WIMAX system, which may reduce waste of air interface bandwidth caused by occupancy, simplify complexity of software implementation in BS and SS, and reduce cost, which may be favorable for interconnection and intercommunication between WIMAX devices of different manufacturers.

The embodiments of the present invention provides a method for realizing dynamic QoS in a WIMAX system, including the following steps:

an MGC (Media Gateway Controller) making awareness of service streams transmitted from an MG (Media Gateway), and transmits a resource request to a resource management server;

the resource management server, in response to the resource request, determines whether there is enough resource in a bearer network;

and if there is enough resource, confirms the resource request, and transmits a resource allocation instruction and QoS parameters matching the type of service to a base station, which, after receiving the resource allocation instruction, allocates resource to a subscriber station, thus a service channel from the MGC to the MG via the base station and the subscriber station is established;

or denies the resource request if there is not enough resource.

### BRIEF DESCRIPTION OF THE DRAWINGS

FIG. 1 is a schematic diagram of an architecture of implementation of dynamic QoS in a WIMAX system;

FIG. 2 is a flow chart of implementing dynamic QoS when a resource request succeeds in an embodiment of the present invention;

FIG. 3 is a flow chart of processing when a resource request fails in an embodiment of the present invention;

FIG. 4 is a flow chart of implementing dynamic QoS when a resource request succeeds in an embodiment of the present invention;

FIG. 5 is a flow chart of processing when a resource request fails in an embodiment of the present invention;

FIG. 6 is a flow chart of implementing dynamic QoS when a resource request succeeds in an embodiment of the present invention;

FIG. 7 is a flow chart of processing when a resource request fails in an embodiment of the present invention.

### DETAILED DESCRIPTION OF THE EMBODIMENTS

The present invention will be further described in conjunction with the accompanying drawings and the following embodiments.

Hereafter, the present invention will be described with a soft switch device Softswitch used as an MGC and an integrated access device IAD used as MG.

FIG. 1 shows a schematic diagram of system architecture of implementing dynamic QoS in a WIMAX system, which mainly includes: IAD (integrated access device), BS (base station), SS (subscriber station), BAS (Broadband Access Server), soft switch device Softswitch and RM (resource management); and in addition, also includes a calling terminal and a called terminal, at least one of which is a wireless access terminal.

The IAD, which serves as an MG, is directly connected to subscriber terminals, used to receive data and voices from the terminals, and processes media streams. IAD is only a kind of MG, and, as an MG, it can be replaced with AG (Access Gateway), AMG (Access Media Gateway), UMG (universal Media Gateway), STB (Set-Top-Box) or IP video telephone, etc.

IAD, SS and BS are successfully connected and form a service channel. BAS and BS are connected with each other implementing management of broadband access subscribers. Softswitch, serving as an MGC, is connected with the BAS and controls the IAD to perform calling process. After receiving a resource request from the Softswitch, an RM, according to network topology and usage of resource, decides whether to admit the request and perform CAC (connection admission control), i.e., whether to process DSA/DSC/DSD request from SS, wherein, RM is responsible for management of network resource, determines whether there is enough resource in a bearer network (IP backbone network) and interacts with the bearer network using COPS protocol to ensure that there is enough resource on path of a service stream and to guarantee End-to-End QoS.

A service flow of the present invention will be described in detail taking VoIP service as an example.

(I) when the calling terminal is a wireless access terminal and the called terminal in a wired access terminal:

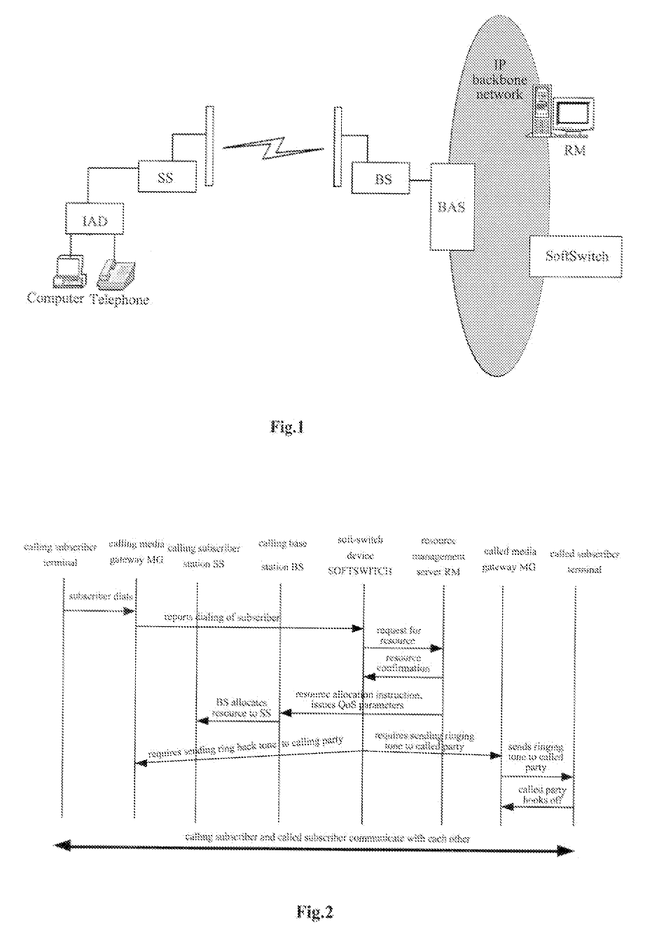

FIG. 2 illustrates a service flow when a resource request succeeds according to an embodiment of the invention. The first step: the calling subscriber terminal dials, which is reported to the Softswitch via the calling IAD, the calling SS and the calling BS successively; the Softswitch requests resource from the RM; the BS and the SS do not make awareness of the service and the Softswitch makes awareness of the service. The second step: the RM determines that there is enough resource in the current bearer network and transmits an resource confirmation signal to the Softswitch, transmits a resource allocation instruction to the calling BS at the same time and issues QoS parameters matching the type of the service. Resource is allocated from the calling BS to the calling SS. QoS parameters are issued dynamically by the RM instead of being configured statically on the BS and the SS. The RM negotiates resource with the calling BS by means of COPS protocol, both of the RM and the BS supporting COPS protocol. A connection between the BS and the SS is established by means of DSA (dynamic service addition) signal request), and bandwidth can be allocated only after the connection is established.

The third step: after attaining resource, the Softswitch continues communications with the calling MG and the called MG respectively. The Softswitch notifies the calling MG to send a ring back tone to the calling terminal, and notifies the called MG to send a ringing tone to the called terminal. The fourth step: when the called terminal hooks off, a service stream between the calling terminal and the called terminal is activated and voice communication between the calling terminal and the called terminal starts. A service stream between the calling terminal and the called terminal is activated only when the called terminal is put through, and at that time the service stream will occupy air-interface bandwidth.

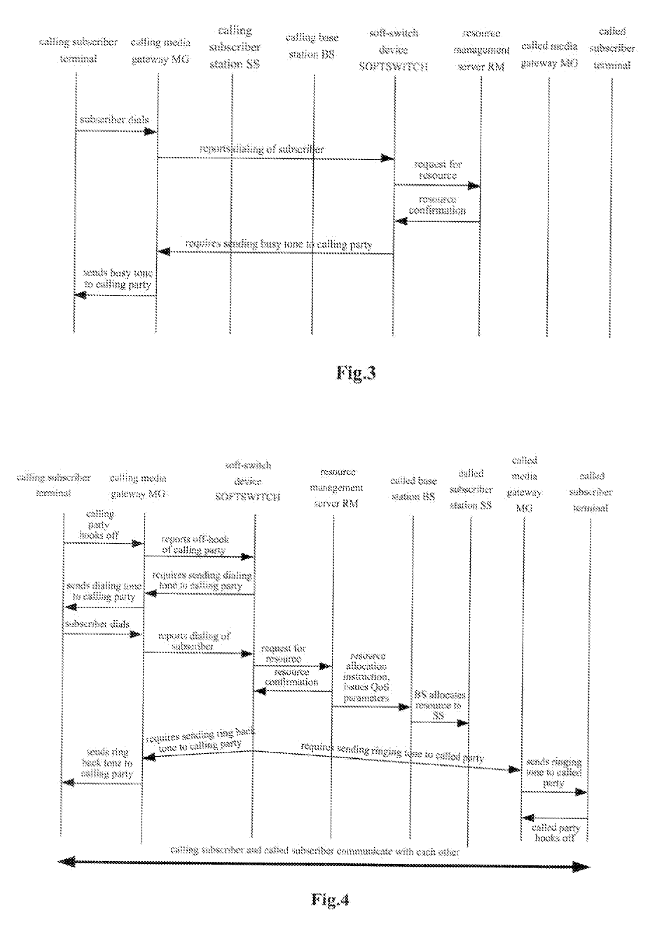

FIG. 3 illustrates a service flow when a resource request fails according to an embodiment of the invention. The first step: the calling subscriber terminal hooks off and dials, which is reported to the Softswitch via the calling MG (IAD shown in FIG. 1), the calling SS and the calling BS successively, and the Softswitch requests resource from the RM; the second step: the RM determines that there is not enough resource in the current bearer network and transmits a resource denial signal to the Softswitch; the calling MG sends a busy tone back to the calling terminal, and the calling party hangs up. Voice communication requirement is denied and air interface bandwidth is not occupied by service streams.

(II) When the calling terminal is a wired access terminal and the called terminal is a wireless access terminal:

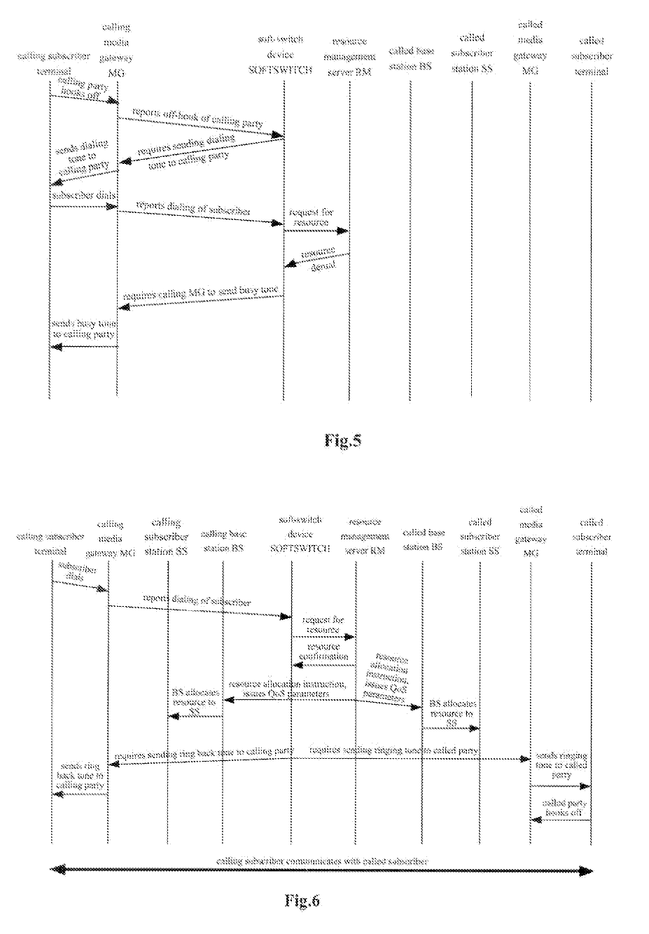

FIG. 4 illustrates a service flow when a resource request succeeds. The first step: the calling subscriber terminal hooks off, and the calling MG reports the off-hook information to the Softswitch; the second step: the Softswitch notifies the calling MG to transmit a dialing tone to the subscriber terminal; the third step: the calling subscriber terminal dials, and the Softswitch requests resource from an RM immediately after the calling MG reports the dialing to the Softswitch; the fourth step: the RM determines that there is enough resource in the current bearer network, transmits a resource confirmation signal to the Softswitch, transmits a resource allocation instruction to the called BS at the same time, and issues QoS parameters. The called BS allocates resource to the called SS correspondingly, and the RM negotiates resource with the called BS by means of COPS protocol. The called BS transmits a DSA request to the called SS, and bandwidth is allocated after a connection is established; the fifth step: the Softswitch continues its voice communications with the calling MG and the called MG respectively; the Softswitch notifies the calling MG to send a ring back tone to the calling terminal, and notifies the called MG to send a ringing tone to the called terminal simultaneously; the sixth step: when the called terminal hooked off, a service stream between the calling terminal and the called terminal is activated, and voice communications between the calling terminal and the called terminal is established.

FIG. 5 illustrates a service flow when a resource request fails according to an embodiment of the invention. The first step: the calling subscriber terminal hooks off, and the MG reports the off-hook information to the Softswitch; the second step: the Softswitch notifies the calling MG to transmit a dialing tone to the subscriber terminal; the third step: the calling subscriber terminal dials, and the Softswitch requests resource from the RM immediately after the calling MG reports the dialing information to the Softswitch; the fourth step: the RM determines that there is not enough resource in the current bearer network and transmits a resource denial signal to the Softswitch, and the calling MG sends a busy tone back to the calling terminal.

(III) When the calling terminal and the called terminal are both wireless access terminals:

FIG. 6 illustrates a service flow when a resource request succeeds according to a embodiment of the invention. The first step: the calling subscriber terminal dials, which is reported to the Softswitch via the calling MG (IAD shown in FIG. 1), the calling SS and the calling BS successively, and the Softswitch requests resource from the RM; the second step: the RM determines that there is enough resource in the current bearer network, transmits a resource confirmation signal to the Softswitch, transmits an instruction of resource allocation to the calling BS and the called BS simultaneously and issues QoS parameters. The calling BS allocates resource to the calling SS accordingly and the called BS allocates resource to the called SS accordingly. RM negotiates resource with the calling BS and the called BS respectively by means of COPS protocol. After attaining resource, the calling BS originates a DSA request to the calling SS, a connection is established and bandwidth is allocated; at the same time, the called BS originates a DSA request to the called SS, a connection is established and bandwidth is allocated. The third step: the Softswitch continues its voice communications with the calling MG and the called MG respectively, and the Softswitch notifies the calling MG to send a ring back to the calling terminal, and notifies the called MG to send a ringing tone to the called terminal simultaneously; the fourth step: when the called terminal hooks off, a service stream between the calling terminal and the called terminal is activated and voice communications between the calling terminal and the called terminal are established.

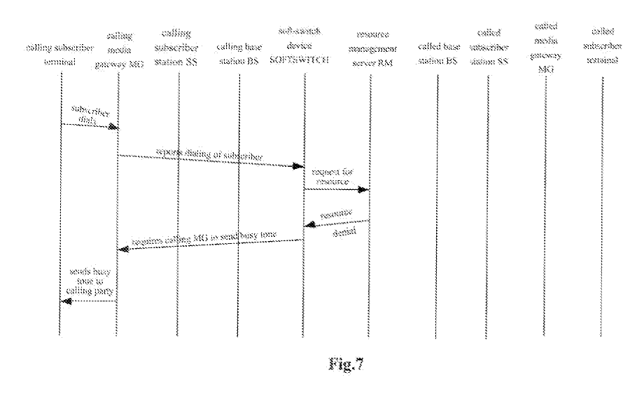

FIG. 7 illustrates a service flow when a resource request fails according to an embodiment of the invention. The first step: the calling terminal subscriber dials, which is reported to the Softswitch via the calling MG (IAD shown in FIG. 1), the calling SS and the calling BS successively, and the Softswitch requests resource from the RM; the second step: the softswitch determines that there is not enough resource in the current bearer network and transmits a resource denial signal to the Softswitch; the calling MG sends a busy tone back to the calling terminal.

In addition to VoIP, the above method for realizing dynamic QoS can also be applied to services such as VOD and videoconference, etc. The processing thereof is similar to the above and will not be described again.

The above embodiments of the present invention are described by taking a sift switch device Softswitch as an MGC, an integrated access device IAD as an MG, but apparently, other similar devices which can function as MGC or MG can also be applied herein.

It will be apparent to those skilled in the art that the present invention does not limit to the above specific embodiments and various modifications and variations can be made in the present invention without departing from the spirit or scope of the inventions. It is intended that the present invention covers the modifications and variations provided they come within the scope of the appended claims and their equivalents.

1. A method for realizing dynamic QoS in a Worldwide Interoperability for Microwave Access (WIMAX) system, comprising:
a Media Gateway Control (MGC) making awareness of a service stream transmitted from a Media Gateway (MG) and transmitting a resource request to a resource management server;
the resource management server, in response to the resource request, determining whether there is enough resource in a bearer network; and
if there is enough resource, the resource management server acknowledging the resource request, and transmitting a resource allocation instruction and QoS parameters matching type of the resource to a base station, and after receiving the resource allocation instruction, the base station allocating resource to a subscriber station, thus a service channel from the MGC to the MG via the base station and the subscriber station being established;
if there is not enough resource, the resource management server refusing the resource request.

2. The method for realizing dynamic QoS in a WIMAX system according to claim 1, further comprising: when the service channel is established, the MGC instructing an associated MG to transmit a prompt signal to a calling terminal and a called terminal respectively.

3. The method for realizing dynamic QoS in a WIMAX system according to claim 2, further comprising: when the called terminal answers, a service stream between the calling terminal and the called terminal is activated.

4. The method for realizing dynamic QoS in a WIMAX system according to claim 1, further comprising: when the resource request is refused, the MGC notifying the MG to send a busy tone back to a calling terminal.

5. The method for realizing dynamic QoS in a WIMAX system according to claim 1, further comprising:
a calling terminal reporting request information to the MGC via the MG;
the MGC notifying an associated MG to transmit a prompt signal to the calling terminal and a called terminal respectively;
the calling terminal dialing and the MG reporting the dialing information to the MGC.

6. The method for realizing dynamic QoS in a WIMAX system according to claim 1, wherein, the resource management server negotiates resource with the base station using Common Open Policy Service protocol;
a connection between the base station and the subscriber station is established by means of a Dynamic Service Addition signal request, and resource is allocated after the connection is established.

7. The method for realizing dynamic QoS in a WIMAX system according to claim 1, further comprising:
when a calling terminal is a wireless access terminal and a called terminal is a wired access terminal, the base station being a calling base station and the subscriber station being a calling subscriber station.

8. The method for realizing dynamic QoS according to claim 1, further comprising:
when a calling terminal is wired access terminal and a called terminal is a wireless access terminal, the base station being a called base station and the subscriber station being a called subscriber station.

9. The method for realizing dynamic QoS in a WIMAX system according to claim 1, further comprising:
when a calling terminal and a called terminal are both wireless access terminals, the base station being a calling base station or a called base station, the subscriber station being a calling subscriber station or a called subscriber station.

10. The method for realizing dynamic QoS in a WIMAX system according to claim 1, wherein, the media gateway is Integrated Access Device (IAD), Access Gateway (AG), Access Media Gateway (AMG), or Universal Media Gateway (UMG).

11. A WIMAX system comprising:
a Media Gateway (MG), a Media Gateway Control (MGC), a resource management server, a base station and a subscriber station;
wherein the MGC makes awareness of a service stream transmitted from the MG and transmits a resource request to the resource management server;
the resource management server, in response to the resource request, determines whether there is enough resource on the bearer network; and
if there is enough resource, the resource management server acknowledges the resource request, and transmits a resource allocation instruction and QoS parameters matching type of the resource to a base station, and after receiving the resource allocation instruction, the base station allocates resource to the subscriber station, thus a service channel from the MGC to the MG via the base station and the subscriber station is established.

12. The WIMAX system according to claim 11, wherein: an associated MG is instructed by the MGC to transmit a prompt signal to a calling terminal and a called terminal respectively when the service channel is established.

13. The WIMAX system according to claim 11, wherein, the MG is connected to subscriber terminals, for receiving data and voices from the terminals.

14. The WIMAX system according to claim 11, wherein, the MG is Integrated Access Device (IAD), Access Gateway (AG), Access Media Gateway (AMG), or Universal Media Gateway (UMG).

15. The WIMAX system according to claim 11, further comprising a Broadband Access Server (BAS) connected with the BS for implementing management of broadband access subscribers.

16. The WIMAX system according to claim 11, wherein, the MGS is a soft switch device.
